(19) United States
(12) Patent Application Publication
(10) Pub. No.: US 2024/0338595 A1
(43) Pub. Date: Oct. 10, 2024

(54) TESTING MEMBERSHIP IN DISTRIBUTIONAL SIMPLEX

(71) Applicant: INTERNATIONAL BUSINESS MACHINES CORPORATION, ARMONK, NY (US)

(72) Inventors: Kanthi Sarpatwar, Briarcliff Manor, NY (US); Karthikeyan Shanmugam, Bengaluru (IN); Venkata Sitaramagiridharganesh Ganapavarapu, YORKTOWN, NY (US)

(21) Appl. No.: 18/191,580

(22) Filed: Mar. 28, 2023

(51) Int. Cl. G06N 20/00

(52) U.S. Cl. CPC G06N 20/00

(57) ABSTRACT

A method for determining whether a target dataset is in a convex hull of a plurality of source datasets is disclosed. The method includes obtaining the target dataset drawn from an unknown target distribution and the plurality of source datasets, wherein each source dataset is drawn from an unknown source distribution; assigning a sampling weight to each source distribution; constructing a mixed dataset comprising a plurality of samples drawn from source distributions according to the sampling weights of the source distributions; computing a sample based maximum mean discrepancy (MMD) measure between the target dataset and the mixed dataset; and determining that the target dataset is in the convex hull of the plurality of source datasets when the MMD measure is less than or equal to a threshold; otherwise determining that the target dataset is not in the convex hull of the plurality of source datasets.

### BACKGROUND

A machine learning model is a type of artificial intelligence (AI) model that uses algorithms and statistical models to learn patterns and relationships in data, and make predictions or decisions without being explicitly programmed. Machine learning models use large datasets to train, and they can improve their accuracy over time as they are exposed to more data.

There are many different types of machine learning models, including supervised learning, unsupervised learning, and reinforcement learning. In supervised learning, the model is trained using labeled data, which means that the input data and the expected output are provided to the model during training. In unsupervised learning, the model is trained using unlabeled data, and it must find patterns and relationships on its own. Reinforcement learning involves training a model to make decisions based on a reward system, where the model learns to maximize its reward by making good decisions.

Machine learning models can be used for a wide range of applications, such as image and speech recognition, natural language processing, recommendation systems, and predictive analytics. They are an essential tool in modern AI systems and are used in a wide range of industries, including healthcare, finance, transportation, and many others.

### SUMMARY

The present disclosure provides various systems and method for testing membership in a distributional simplex. Various technical applications of the present disclosure include determining whether a target data set could have been sampled from a plurality of source distributions, and given a data shift, determining a type of data shift.

In an embodiment of the present disclosure, a method for determining whether a target dataset is in a convex hull of a plurality of source datasets is disclosed. The method includes obtaining the target dataset drawn from an unknown target distribution and the plurality of source datasets. Each source dataset in the plurality of source datasets is drawn from an unknown source distribution. The method assigns a sampling weight to each source distribution. The method constructs a mixed dataset comprising a plurality of samples drawn from source distributions according to the sampling weights of the source distributions. The method computes a sample based maximum mean discrepancy (MMD) measure between the target dataset and the mixed dataset. The method determines that the target dataset is in the convex hull of the plurality of source datasets when the MMD measure is less than or equal to a threshold; otherwise, the method determines that the target dataset is not in the convex hull of the plurality of source datasets when the MMD measure is greater than the threshold.

Other embodiments including a system and computer program product are further described in the detailed description.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram illustrating a machine learning prediction process in accordance with an embodiment of present disclosure.

FIG. 2 is a flowchart illustrating a method for determining a type of data shift based on whether a target dataset is in the convex hull of the plurality of source datasets in accordance with an embodiment of the present disclosure.

FIG. 3 is a block diagram illustrating a hardware architecture of a system according to an embodiment of the present disclosure in which aspects of the illustrative embodiments may be implemented.

The illustrated figures are only exemplary and are not intended to assert or imply any limitation with regard to the environment, architecture, design, or process in which different embodiments may be implemented.

### DETAILED DESCRIPTION

It should be understood at the outset that, although an illustrative implementation of one or more embodiments are provided below, the disclosed systems, computer program product, and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used within the written disclosure and in the claims, the terms “including” and “comprising” are used in an open-ended fashion, and thus should be interpreted to mean “including, but not limited to.” Unless otherwise indicated, as used throughout this document, “or” does not require mutual exclusivity, and the singular forms “a”, “an” and “the” are intended to include the plural forms as well, unless the context clearly indicates otherwise.

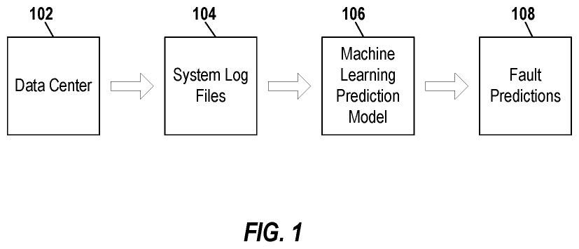

FIG. 1 is a schematic diagram illustrating a machine learning prediction process in accordance with an embodiment of the present disclosure. In particular, FIG. 1 illustrates an example a machine learning prediction process of a cloud and data center root cause analysis process. In the depicted embodiment, system log files 104 are generated from the operations of a data center 102. The system log files 104 include various system parameters or symptoms that occur in the data center 102. The system log files 104 may include information on resource usage such as, but not limited to, memory, disk, or processor (e.g., random-access memory (RAM) memory usage exceeded by 90%, disk usage exceeded by 90%, etc.).

A machine learning model 106 is trained based on the information in the system log files 104 to predict a type of fault 108 (e.g., network switch fault, microservice not responding, etc.) corresponding to one or more symptoms (encoded as features). Every fault (e.g., alerts produced by monitoring tools) may be associated with a series of symptoms such as disk usage exceeding X%, memory usage exceeding Y%, or processor usage exceeding Z%. Different types of faults would produce a distinct sequence of symptoms. In an embodiment, to train the machine learning model 106, for each fault type, a dataset is constructed containing proportions of various symptoms corresponding to the fault type.

Once the machine learning model 106 is trained using the data from the system log files 104 (i.e., training data), the machine learning model 106 can then be used to predict the type of faults 108 on new data referred to as test data (e.g., data from new system log files). However, the machine learning model 106 will fail to work well when there is a change in data patterns (i.e., data shift) between the training data and test data.

Data shift is a common problem in predictive modeling. Data shift refers to a change in the distribution of the training data compared to the distribution of the test data. In other words, the model is trained on a certain distribution of data, but when it is deployed to make predictions, the distribution of the data it encounters is different. This can lead to a decrease in the model's performance, as it has not seen the types of data that it will encounter in the real world.

There are two main types of data shifts that can occur: target data shift and covariate data shift. A target data shift, also known as label shift or output shift, refers to changes in the distribution of the target variable or the output of a machine learning model. Thus, for a target data shift, the distribution of the predicted values or labels in the test data differs from the distribution of the predicted values or labels in the training data. In contrast, a covariate data shift occurs when the distribution of input features, referred to as covariates, in the training data differs from the distribution of input features in the test data. These types of data shifts can cause the model to perform poorly on the test data, even if it has high accuracy on the training data.

For example, in FIG. 1, the machine learning model 106 may fail to work well due to shifts in the data patterns between the training data and test data due to changes in the frequencies of faults or changes in the symptoms generated by a particular fault. For instance, from week to week, the proportion of faults will change, but the fault to symptoms mapping may remain the same. For example, for a video hosting cloud company, user traffic during holidays is large, triggering lots of network faults compared to other times. In this case, trying to predict fault from symptoms using the machine learning model 106 may fail to work well. This type of data shift is a target data shift. Additionally, in some cases, symptoms mapping to faults also shifts significantly (i.e., a covariate data shift), which requires a different approach than a target data shift to adapt (i.e., update) the machine learning model 106 to the data shift. Thus, it would be beneficial to be able to determine a type of data shift (e.g., target data shift or a covariate data shift) affecting a machine learning model.

The disclosed embodiments provide a method for addressing the above problem with data shifts, as well as being applicable to other applications, by providing a method that determines whether a given dataset could have been sampled from k source distributions. Additionally, the disclosed embodiments extend the two sample MMD test as presently perform, which deals with a single source distribution (k=1), to enable a mechanism to test whether a target dataset was drawn from multiple source datasets (i.e., determining whether a given target distribution belongs to the convex hull of k source distributions, where k>1. The convex hull of k source distributions is a set of probability distributions that can be obtained by taking convex combinations of the k source distributions. More specifically, the convex hull of a set of probability distributions is the smallest convex set that contains all the source distributions (i.e., the smallest convex polygon or polyhedron that encloses all the source distributions). In an embodiment, given k distributions p₁, p₂, . . . , pₖ, the convex hull is defined as convhull (p₁, p₂, . . . , pₖ)={Σᵢ₌₁^{k}wᵢpᵢ:Σᵢ₌₁^{k}wᵢ=1}.

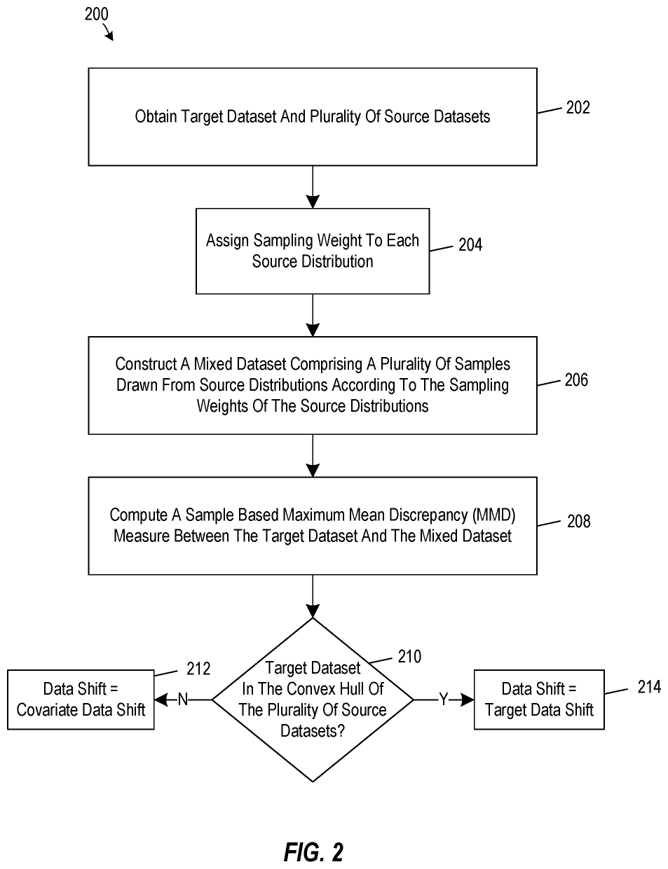

For example, FIG. 2 is a flowchart illustrating a method 200 for determining a type of data shift based on whether a target dataset is in the convex hull of the plurality of source datasets in accordance with an embodiment of the present disclosure.

The method 200 includes obtaining, at step 202, a target dataset q and a plurality of source datasets (P₁, P₂, . . . . Pₖ). Each source dataset Pᵢ in the plurality of source datasets is drawn from an unknown source distribution. Unknown source distribution refers to a situation where the distribution of the training data is significantly different from the distribution of the test data (e.g., the training data is drawn from a different population or environment than the test data), but the specific nature of the difference is unknown or difficult to determine. Additionally, the target dataset is drawn from an unknown target distribution, where the distribution of the target variable in the test data is significantly different from the distribution of the target variable in the training data), but the specific nature of the difference is unknown or difficult to determine. For example, in FIG. 1, the target dataset q, is the target distribution of symptoms (over all faults) using the testing dataset.

The method, at step 204, assigns a sampling weight (e.g., a weight vector) to each source distribution. A sampling weight is a factor used to adjust for differences in the probability of selection of a source distribution. In an embodiment, the sampling weight assigned to each source distribution may initially be uniform on each source dataset. As described below, in an embodiment, a mirror descent optimization algorithm may be executed to improve or optimize the sampling weight for minimizing a loss function.

The method, at step 206, constructs a mixed dataset comprising a plurality of samples independently drawn from the plurality of source datasets (P₁, P₂, . . . . Pₖ) according to the sampling weights of the source distributions. The candidate mixed distribution may include samples drawn independently from a source distribution, where the source distribution is selected with a probability proportional to a current sampling weight of the source distribution.

The method, at step 208, computes a sample based MMD measure between the target dataset and the mixed dataset. MMD is a widely used distance measure for distributions. MMD measures the maximum difference in the expected function values of samples from two distributions. In an embodiment, the MMD between two distributions p and q defined on a universe U is determined using the following equation:

$$M M D [ F , p , q ] := {sup}_{f ∈ F} ( {E}_{x \sim p} [ f ( x ) ] - {E}_{y \sim q} [ f ( y ) ] )$$

where F is a class of functions defined on the universe U. The above definition of MMD assumes access to the actual distribution, which is often the not the case. Instead, often a representative set of samples are provided from each distribution. For example, in an embodiment, the sampled version of MMD (represented as M\hat{M}D) between two sample datasets X={x₁, x₂, . . . , xₙ}˜p and Y={y₁, y₂, . . . , yₙ}˜q defined on the universe U, and where F is determined using the following equation:

$$M \hat{M} D [ F , p , q ] := {sup}_{f ∈ F} ( \frac{1}{n} {\sum }_{i = 1}^{n} f ( {x}_{i} ) - \frac{1}{m} {\sum }_{i = 1}^{m} f ( {y}_{i} ) )$$

In an embodiment, the class of functions can be drawn from arbitrary class of functions. In other embodiments, the class of functions can be drawn from a well-behaved class functions such as a unit norm ball in a reproducible kernel Hilbert space (RKHS) H. A RKHS is a Hilbert space of functions in which point evaluation is a continuous linear functional. In an embodiment, the kernel of H by K and the corresponding feature mapping is denoted by Φ(x)=K(x, .). The mean embedding of a distribution p, denoted by μₚ∈H, is an element satisfying the equation [symbol] _{x˜p}f= [symbol] f, μₚ [symbol] , where ↑ₚ(t)= [symbol] _{x˜p}K(t, x).

At step 210, the method 200 determines whether the target dataset is in the convex hull of the plurality of source datasets. In an embodiment, the target dataset is in the convex hull of the plurality of source datasets is represented by the null hypothesis [symbol] ₀q∈convhull (P₁, P₂, . . . . Pₖ), and the target dataset is not in the convex hull of the plurality of source datasets is represented by an alternative hypothesis [symbol] ₁: q is ϵ away from the conv hull. Thus, the target dataset is in the convex hull of the plurality of source datasets when [symbol] ₀ is true (and correspondingly [symbol] ₁ is false) and the target dataset is not in the convex hull of the plurality of source datasets when [symbol] ₁ is true (and correspondingly Ho is false).

In an embodiment, given independent and identically distributed (i.i.d) samples from k distributions P₁˜p₁, P₂˜p₂, . . . , Pₖ˜pₖ and i.i.d samples Q˜q, distinguish for some separation ϵ>0 between [symbol] ₀ and [symbol] ₁. In an embodiment, Hjis represented by the following equation:

$${ℋ}_{1} : {inf}_{w ϵΔ} M M D ( H , {\sum }_{i = e}^{k} {w}_{i} {p}_{i} , q ) \geq ϵ$$

As stated above, [symbol] ₀(i.e., the null hypothesis) states that the target distribution q is in the convex hull of the given source distributions. [symbol] ₁(i.e., the alternative hypothesis) states that the target distribution q is sufficiently far away ϵ from the closest point in the convex hull. Δ={w: Σᵢ₌₁^{k}wᵢ=1} is the unit simplex of weight vectors.

In an embodiment, to determine [symbol] ₁ for given distributions p and q for which the mean embedding μₚ and μ_{q} exist, the equation MMD [Fm p, q]=∥μₚ−μ_{q}∥² is used.

A loss function L is defined as the squared norm of the difference in mean embeddings of Σᵢ₌ₑ^{k}wipi and q as shown in the following equation:

$$ℒ ( w ) = {‖ {\sum }_{i = 1}^{k} {w}_{i} {𝔼}_{x ∈ {p}_{i}} [ Φ ( x ) ] - {𝔼}_{x ∈ q} [ Φ ( x ) ] ‖}_{ℋ}^{2}$$

where Φ denotes the feature map of H. The loss function L measures the difference between the predicted output of a model and the actual target output.

In an embodiment, to reduce the sample complexity involved, the disclosed embodiments use a stochastic variant of the loss function L involving a single sample drawn from each of the distributions. In an iteration t, for sample xᵢ∈Pᵢ and y∈Q, the stochastic loss function in that iteration is given by the following equation:

$${ℒ}_{t} ( w ) = {‖ {\sum }_{i = 1}^{k} {w}_{i} Φ ( {x}_{i} ) - Φ ( y ) ‖}_{ℋ}^{2}$$

The constrained optimization problem to compute can now be represented as: w*=arg min_{w∈Δ}L(w). In an embodiment, because the constraint space is a simplex Δ (i.e., a geometric object that is defined as the smallest convex polytope with n+1 vertices in n dimensions), a mirror descent algorithm is applied using generalized Kullback-Leibler (KL) divergence as the underlying Bregman divergence. The mirror decent algorithm is an iterative optimization algorithm that performs perform gradient descent using a mirror function that captures the geometry of the optimization problem by defining a distance or divergence between points in the parameter space. A KL divergence is a measure indicating how one probability distribution is different from a second probability distribution. A Bregman divergence or Bregman distance is a measure of difference between two points, defined in terms of a strictly convex function. The general mirror descent algorithm works iteratively (starting from some initialization of weight vector w₀) by updating the weights as follows:

$${w}_{t + 1} = arg {min}_{w} η 〈 ∇ {ℒ}_{t} ( {w}_{t} ) , w - {w}_{t} 〉 + {D}_{φ} ( w , {w}_{t} )$$

Do is the Bregman distance which is defined for a strictly convex and differentiable function φ as D_{φ}(x, y)=φ(x)−φ(y)− [symbol] ∇φ(y), y−x [symbol] . ∇ [symbol] ₜ(wₜ) is the gradient (represented by □ symbol) of the stochastic loss function [symbol] ₜ. The gradient denotes the direction of greatest change of a scalar function (e.g., the direction in which the function increases most quickly from a point p). In an embodiment, the gradient of the stochastic loss function [symbol] ₜ is determined using just the kernel evaluations K (.,.) of the RKHS H. For example, for any wϵ∇, the gradient of the stochastic loss function [symbol] ₜ is determined by the following equation:

$$∇ {L}_{t} ( w ) [ i ] = 2 ( {\sum }_{j = 1}^{k} K ( {x}_{i} , {x}_{j} ) {w}_{j} - K ( {w}_{i} , y ) ) for i ∈ [ k ]$$

In an embodiment, given two vectors X={x₁, x₂, . . . , xₚ} and Y={y₁, y₂, . . . , yₚ}, the generalized KL divergence is determined using the following equation:

$${D}_{φ} ( x , y ) = {\sum }_{i = 1}^{p} {x}_{i} log \frac{{x}_{i}}{{y}_{i}} - {\sum }_{i = 1}^{p} ( {x}_{i} - {y}_{i} )$$

As a non-limiting example, the following mirror descent algorithm can be used to optimize (i.e., minimize) the loss function [symbol] (w).

```
Input: Data sets [P₁ ~ p₁]_{iϵ[k]} and Q~q; T ← |Pᵢ| = |Q|
Output: Weight vector wₜ ϵ Δ
$Initialize {w}_{0} = [ \frac{1}{k} , \frac{1}{k} , … , \frac{1}{k} ] and set η = 1 / \sqrt{T} .$
for every t ∈ [1, T − 1] do
  {Draw samples from xᵢ ∈ Pᵢ and y ∈ Q.
  Let wₜ = (wₜ¹, w², ... , wₜ^{k})
  Update weights to wₜ₊₁ as follows:
  for i ∈ [1, 2, ... k] do
    Compute ∇ [symbol]  ₜ (wₜ) [i] = Σⱼ₌₁^{k} K(xᵢ, xⱼ)wⱼ − K(xᵢ, y))
    $Update {w}_{t + 1}^{i} = \frac{{w}_{t}^{i} {e}^{- η ∇ {ℒ}_{t} ( {w}_{t} ) [ i ]}}{{\sum }_{j = 1}^{k} {w}_{t}^{j} {e}^{- η ∇ {ℒ}_{t} ( {w}_{t} ) [ j ]}}$
  end
end
$return {w}_{T} = \frac{{\sum }_{t} {w}_{t}}{T}$
```

In the above mirror descent algorithm for optimizing the loss function [symbol] (w), the algorithm receives as input data input source datasets: [Pᵢ˜Pᵢ]_{i∈[k]}; target dataset: Q˜q, and T, which is the number of samples provided for each distribution. The mirror descent algorithm outputs/returns the average weight vector

$${w}_{T} = \frac{{\sum }_{t} {w}_{t}}{T} .$$

The algorithm begins by initializing setting the initial weight vector to

$${w}_{0} = [ \frac{1}{k} , \frac{1}{k} , … , \frac{1}{k} ] ,$$

i.e., uniform in each dimension. The learning rate η is set to 1/\sqrt{T}. The algorithm performs T iterations, where a sample is drawn in each iteration [i] from each of source dataset Pᵢ and target dataset Q, computes the gradient ∇ [symbol] ₜ(wₜ)[i], and updates the weight vector wₜ₊₁ⁱ. After T iterations, the average weight vector

$${w}_{T} = \frac{{\sum }_{t} {w}_{t}}{T}$$

is returned (i.e., outputted).

Applying the above mirror descent algorithm for an optimal weight vector w* and learning rate η=1/\sqrt{T}, the present disclosure develops the following concentration inequality theorem:

$$P ( L ( {w}_{T} ) \geq L ( w \text{*)} + \frac{2 {M}^{2} + log K}{\sqrt{T}} + ϵ ) \leq exp ( - \frac{T {ϵ}^{2}}{32 {M}^{2}} )$$

Using the above concentration inequality theorem, the present disclosure provides the following algorithm/method for testing membership in a distributional simplex.
Input: Source datasets: [Pᵢ˜Pᵢ]_{i∈[k]}; Target dataset: Q˜q; Significance level: α
Output: Accept or reject ( [symbol] ₀) where the target is in the convex hull of the source datasets (i.e., Q∈convhull (P₁, P₂, . . . , Pₖ))
Compute weight vector ŵ that minimizes the loss function [symbol] (w);
Obtain Q samples from source datasets according to ŵ;
Compute the unbiased MMD estimate MMD (H, P, Q);
if M\hat{M}D (H, P, Q)≥p (α) then return [symbol] ₁ (i.e., reject ( [symbol] ₀)) else return [symbol] ₀ (i.e., accept [symbol] ₀).

In the above testing membership in a distributional simplex algorithm, the algorithm receives as input data input source datasets: [Pᵢ˜Pᵢ]_{i∈[k]}(i.e., P₁, P₂, . . . Pₖ); a target dataset: Q˜q, and a significance level α. The significance level a is the probability for rejecting or accepting the null hypothesis [symbol] ₀ that the target dataset is in the convex hull of the source datasets. In an embodiment, the mirror descent algorithm described above is used in computing the weight vector w that minimizes the loss function [symbol] (w) in a distributional simplex algorithm. In an embodiment, in obtaining the Q samples from source datasets according to ŵ, a set P of T i.i.d. samples is obtained from the sets of P₁, P₂, . . . , Pₖ according to the weight vector ŵ.

As shown in the above algorithm, in an embodiment, the target dataset is in the convex hull of the plurality of source datasets when the MMD measure is less than or equal to a threshold (i.e., [symbol] ₀ is returned by the algorithm). Otherwise, when the MMD measure is greater than the threshold, the method determines that the target dataset is not in the convex hull of the plurality of source datasets (i.e., [symbol] ₁ is returned by the algorithm).

In reference to FIG. 1 and the problem of identifying a type of data shift, when the target dataset is in the convex hull of the plurality of source datasets (i.e., [symbol] ₀: q∈convhull (P₁, P₂, . . . . Pₖ)), then the method determines, at step 212, that the type of data shift is a target data shift, otherwise, the method determines, at step 214, that the type of data shift is a covariate data shift. If the type of data shift is a target data shift, this means that the proportion of fault varies, but symptoms of a given fault does not. Whereas, if the type of data shift is a covariate data shift, this means that both fault proportions and symptoms mapping to faults have shifted significantly which may require a different approach to updating the model. For example, some approaches for adapting the model to target data shift include importance weighting (e.g., reweighting the training examples based on their importance in matching the target distribution), domain adaptation (e.g., mapping from the source domain to the target domain), and transfer learning (e.g., using a pre-trained model as a starting point, and fine-tuning it on the target data). Whereas some approaches for adapting the model to covariate data shift include covariate shift correction (e.g., reweighting the training examples based on their importance in matching the covariate distribution) and feature normalization (e.g., normalizing the features in the training data to have the same mean and variance as the features in the test data).

Although FIG. 2 is described in reference to the problem of data shift, the general problem of testing membership in a distributional simplex (i.e., determining whether a target dataset could have been sampled a plurality of source datasets) is applicable to various other applications. For example, natural application of the disclosed embodiments in the context of domain adaptation may include drawing samples from a training distribution (xᵢ, yᵢ)∈Pₜᵣ and unsupervised samples from test distribution pₜₑ(x, y), and determining whether pₜₑ(x) lies in the convex hull of {pₜᵣ(X|Y=y)}y. Another application applicable to the present disclosure is in the multi-source domain adaptation settings such as when to a test set with limited labels needs to be adapted or updated using labeled data from multiple training sources.

The disclosed embodiments provide a novel hypothesis testing method that succeeds in distinguishing between the null hypothesis ( [symbol] ₀) and the alternative hypothesis ( [symbol] ₁) within probability 1-8 when the number of samples

$$T = Ω ( \frac{{log}^{2} k + log \frac{1}{δ}}{{ϵ}^{2}} ) .$$

Notably, the sample complexity of the disclosed embodiments does not depend on the relative separation of the source distributions. Further, the efficacy of the disclosed embodiments has been validated with experiments on synthetic and real datasets.

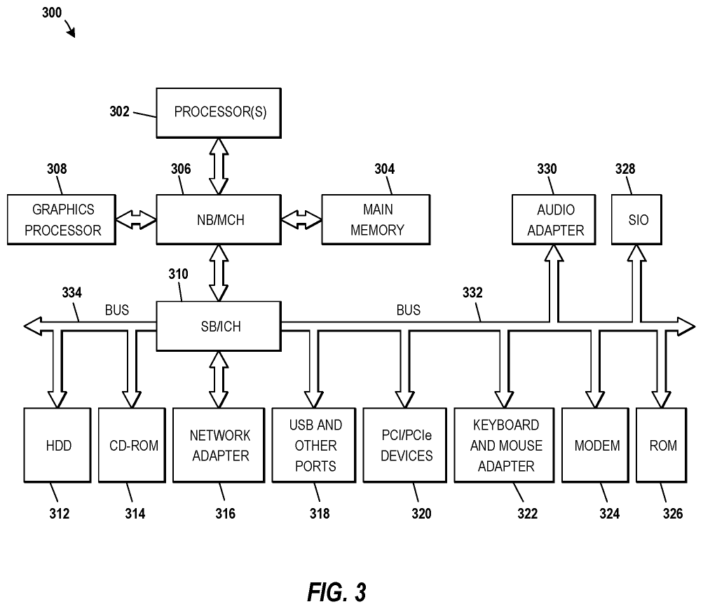

FIG. 3 is a block diagram illustrating a hardware architecture of a system 300 according to an embodiment of the present disclosure in which aspects of the illustrative embodiments may be implemented. For example, in an embodiment, the method 200 for determining a type of data shift based on whether a target dataset is in the convex hull of the plurality of source datasets as shown in FIG. 2 may be implemented using the data processing system 300. In the depicted example, the data processing system 300 employs a hub architecture including north bridge and memory controller hub (NB/MCH) 306 and south bridge and input/output (I/O) controller hub (SB/ICH) 310. Processor(s) 302, main memory 304, and graphics processor 308 are connected to NB/MCH 306. Graphics processor 308 may be connected to NB/MCH 306 through an accelerated graphics port (AGP). A computer bus, such as bus 332 or bus 334, may be implemented using any type of communication fabric or architecture that provides for a transfer of data between different components or devices attached to the fabric or architecture.

In the depicted example, network adapter 316 connects to SB/ICH 310. Audio adapter 330, keyboard and mouse adapter 322, modem 324, read-only memory (ROM) 326, hard disk drive (HDD) 312, compact disk read-only memory (CD-ROM) drive 314, universal serial bus (USB) ports and other communication ports 318, and peripheral component interconnect/peripheral component interconnect express (PCI/PCIe) devices 320 connect to SB/ICH 310 through bus 332 and bus 334. PCI/PCIe devices may include, for example, Ethernet adapters, add-in cards, and personal computing (PC) cards for notebook computers. PCI uses a card bus controller, while PCle does not. ROM 326 may be, for example, a flash basic input/output system (BIOS). Modem 324 or network adapter 316 may be used to transmit and receive data over a network.

HDD 312 and CD-ROM drive 314 connect to SB/ICH 310 through bus 334. HDD 312 and CD-ROM drive 314 may use, for example, an integrated drive electronics (IDE) or serial advanced technology attachment (SATA) interface. In some embodiments, HDD 312 may be replaced by other forms of data storage devices including, but not limited to, solid-state drives (SSDs). A super I/O (SIO) device 328 may be connected to SB/ICH 310. SIO device 328 may be a chip on the motherboard configured to assist in performing less demanding controller functions for the SB/ICH 310 such as controlling a printer port, controlling a fan, and/or controlling the small light emitting diodes (LEDS) of the data processing system 300.

The data processing system 300 may include a single processor 302 or may include a plurality of processors 302. Additionally, processor(s) 302 may have multiple cores. For example, in one embodiment, data processing system 300 may employ a large number of processors 302 that include hundreds or thousands of processor cores. In some embodiments, the processors 302 may be configured to perform a set of coordinated computations in parallel.

An operating system is executed on the data processing system 300 using the processor(s) 302. The operating system coordinates and provides control of various components within the data processing system 300. Various applications and services may run in conjunction with the operating system. Instructions for the operating system, applications, and other data are located on storage devices, such as one or more HDD 312, and may be loaded into main memory 304 for execution by processor(s) 302. In some embodiments, additional instructions or data may be stored on one or more external devices. The processes described herein for the illustrative embodiments may be performed by processor(s) 302 using computer usable program code, which may be located in a memory such as, for example, main memory 304, ROM 326, or in one or more peripheral devices.

The disclosed embodiments may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the disclosed embodiments are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented method, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. Further, the steps of the methods described herein may be carried out in any suitable order, or simultaneously where appropriate. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
obtaining a target dataset drawn from an unknown target distribution and a plurality of source datasets, wherein each source dataset is drawn from an unknown source distribution;
assigning a sampling weight to each source distribution;
constructing a mixed dataset comprising a plurality of samples drawn from source distributions according to the sampling weights of the source distributions;
computing a sample based maximum mean discrepancy (MMD) measure between the target dataset and the mixed dataset;
determining that the target dataset is in a convex hull of the plurality of source datasets when the MMD measure is less than or equal to a threshold; and
determining that the target dataset is not in the convex hull of the plurality of source datasets when the MMD measure is greater than the threshold.

2. The method of claim 1, wherein the mixed dataset comprises samples drawn independently from a source distribution, where the source distribution is chosen with a probability proportional to an optimal sampling weight of the source distribution.

3. The method of claim 1, wherein the sampling weight is initially uniform on each source dataset.

4. The method of claim 3, further comprising executing a mirror descent optimization algorithm to improve the sampling weight for minimizing a loss function.

5. The method of claim 4, wherein the mirror descent optimization algorithm uses a Kullback-Leibler (KL) divergence.

6. The method of claim 3, wherein the sampling weight is computed by minimizing a squared norm of a difference between a mean embeddings of a candidate mixed distribution and the unknown target distribution.

7. The method of claim 1, further comprising determining that a data shift is a target data shift when the target dataset is in the convex hull of the plurality of source datasets.

8. The method of claim 1, further comprising determining that a data shift is a covariate data shift when the target dataset is not in the convex hull of the plurality of source datasets.

9. A system comprising memory for storing instructions, and a processor configured to execute the instructions to:
obtain a target dataset drawn from an unknown target distribution and a plurality of source datasets, wherein each source dataset is drawn from an unknown source distribution;
assign a sampling weight to each source distribution;
construct a mixed dataset comprising a plurality of samples drawn from source distributions according to the sampling weights of the source distributions;
compute a sample based maximum mean discrepancy (MMD) measure between the target dataset and the mixed dataset;
determine that the target dataset is in a convex hull of the plurality of source datasets when the MMD measure is less than or equal to a threshold; and
determine that the target dataset is not in the convex hull of the plurality of source datasets when the MMD measure is greater than the threshold.

10. The system of claim 9, wherein the mixed dataset comprises samples drawn independently from a source distribution, where the source distribution is chosen with a probability proportional to an optimal sampling weight of the source distribution.

11. The system of claim 9, wherein the sampling weight is initially uniform on each source dataset.

12. The system of claim 11, wherein the processor is further configured to execute the instructions to execute a mirror descent optimization algorithm to improve the sampling weight to minimize a loss function.

13. The system of claim 12, wherein the mirror descent optimization algorithm uses a Kullback-Leibler (KL) divergence.

14. The system of claim 11, wherein the sampling weight is computed by minimizing a squared norm of a difference between a mean embeddings of a candidate mixed distribution and the unknown target distribution.

15. The system of claim 9, wherein the processor is further configured to execute the instructions to determine that a data shift is a target data shift when the target dataset is in the convex hull of the plurality of source datasets.

16. The system of claim 9, wherein the processor is further configured to execute the instructions to determine that a data shift is a covariate data shift when the target dataset is not in the convex hull of the plurality of source datasets.

17. A computer program product comprising a computer readable storage medium having program instructions embodied therewith, the program instructions executable by a processor of a system to cause the system to:
obtain a target dataset drawn from an unknown target distribution and a plurality of source datasets, wherein each source dataset is drawn from an unknown source distribution;
assign a sampling weight to each source distribution;
construct a mixed dataset comprising a plurality of samples drawn from source distributions according to the sampling weights of the source distributions;
compute a sample based maximum mean discrepancy (MMD) measure between the target dataset and the mixed dataset;
determine that the target dataset is in a convex hull of the plurality of source datasets when the MMD measure is less than or equal to a threshold; and
determine that the target dataset is not in the convex hull of the plurality of source datasets when the MMD measure is greater than the threshold.

18. The computer program product of claim 17, wherein the mixed dataset comprises samples drawn independently from a source distribution, where the source distribution is chosen with a probability proportional to an optimal sampling weight of the source distribution.

19. The computer program product of claim 17, wherein the sampling weight is initially uniform on each source dataset, and wherein the program instructions executable by the processor of the system further causes the system to execute a mirror descent optimization algorithm to improve the sampling weight to minimize a loss function.

20. The computer program product of claim 17, wherein the sampling weight is computed by minimizing a squared norm of a difference between a mean embeddings of a candidate mixed distribution and the unknown target distribution.
